(19) United States
(12) Patent Application Publication
(10) Pub. No.: US 2019/0305479 A1
(43) Pub. Date: Oct. 3, 2019

(54) MAGNETIC HIGH FREQUENCY CONNECTOR

(71) Applicant: QUANTONG TECHNOLOGY CO., LTD., Taipei City (TW)

(72) Inventor: LI-CHUN LAN, TAIPEI CITY (TW)

(21) Appl. No.: 16/360,021

(22) Filed: Mar. 21, 2019

(30) Foreign Application Priority Data
Mar. 27, 2018 (TW) 107203952

(51) Int. Cl. H01R 13/62; H01R 24/40; H01R 13/627

(52) U.S. Cl. CPC H01R 13/6205; H01R 13/627; H01R 24/40

(57) ABSTRACT

A magnetic high frequency connector includes a male end portion, a first outer casing, a multiple of first magnetic members, at least one moving terminal, a second outer casing and a female end portion. The male end portion has an accommodation space. The first outer casing covers the male end portion and has a multiple of fixing slots. The first magnetic members are installed in the fixing slots, and two adjacent first magnetic members have a magnetic end spacing and are in a heteropolar state. In the accommodation space, a distribution of lines of magnetic force is formed in at least one weak magnetic area and at least one strong magnetic area. The moving terminal is installed in the weak magnetic area. The second outer casing has a magnetic portion. The female end portion is covered by the second outer casing and has at least one fixed terminal.

### CROSS-REFERENCE TO RELATED APPLICATIONS

This non-provisional application claims priority under 35 U.S.C. § 119(a) on Patent Application No(s). 107203952 filed in Taiwan, R.O.C. on Mar. 27, 2018, the entire contents of which are hereby incorporated by reference.

### FIELD OF THE INVENTION

The present invention relates to the field of a connector, more particularly to a magnetic high frequency connector that is applied to a high frequency connector and electrically coupled by magnetic attraction.

### BACKGROUND OF THE INVENTION

### 1. Description of the Related Art

As science and technology are developed rapidly, various electronic products are developed to assist our life and work. Most electronic products require a connector to connect to a power supply in order to use the electronic products or electrically connect to another electronic product in order to transmit digital data. The connector is widely used in the electronic products in different areas including the industrial, medical, communication or other consumer electronic areas, etc. With the development of the electronic products, the performance of the connector is evolved and all kinds of connectors are developed with a compact, high-speed, and interference-resisting design. In recent years, high frequency connectors are further developed to meet the high-speed requirement of the electronic products and improve the signal transmission speed and quality, while avoiding the issues of impedance matching, and electromagnetic interference caused by the high frequency signal transmission.

On the other hand, the operation of the electronic product is often interrupted by tripping over a cable of the high frequency connector. As a result, the signal transmission is interrupted and the high frequency connector is damaged, or even the electronic product electrically connected to the high frequency connector is damaged. Therefore, a magnetic high frequency connector is provided to overcome the aforementioned problem. The magnetic high frequency connector divides the conventional high frequency connector into a plurality of connectors such as a male connector and a female connector, and a magnet is embedded into each of the connectors. Wherein, the female connector is electrically coupled to an electronic product such as a mobile phone or a computer, and the male connector is electrically coupled to another electronic product such as a mobile phone charger or a computer transformer, and a transmission pin in the male connector is electrically coupled to a transmission pin in the female connector, and both transmission pins are provided for the operation of the electronic product (such as charging a mobile phone and transmitting data between a mobile phone and a computer, etc.). Through the magnetic field generated by the magnet, the male and female connectors are electrically coupled to each other by magnetic attraction and provided for transmitting signals and turning on the connected electronic product.

However, the conventional magnetic high frequency connector simply has the magnets installed into the male and female connectors of the high frequency connector respectively. During the operation of the magnetic high frequency connector, the transmission pins of the male and female connectors are electrically coupled to each other, and the electromagnetic field generated by the magnet and the electronic product will interfere the transmission of the high frequency signal, and the factor causing such interference stems from the magnetic field generated by the magnet of the magnetic high frequency connector. With reference to FIGS. 1A and 1B for the distribution of lines of magnetic force, the figures show the cross-section of the male connector. In the figures, the dots represent the transmission pins 41, the curves represent the simulated lines of magnetic force, the arrows indicate the direction of the magnetic field, and N and S represent the positive pole and the negative pole of the magnet respectively. The difference between FIGS. 1A and 1B is that the positive pole and the negative pole of the magnet 4 are reversed. From the distribution of lines of magnetic force as shown in the figures, the transmission pin 41 is densely covered by the lines of magnetic force. In other words, the magnetic field generated by the magnet 4 of the connector will interfere with the operation of the transmission pin 41 severely. Therefore, the signal transmission of the conventional magnetic high frequency connector is interfered by the magnetic field, and the transmission efficiency and quality of the signal are adversely affected.

In view of the aforementioned drawbacks of the conventional magnetic high frequency connector, the inventor of the present invention based on years of experience in the related industry to conduct extensive research and experiment, and finally developed a magnetic high frequency connector to overcome the drawbacks of the prior art,

### 2. Summary of the Invention

Therefore, it is a primary objective of the present invention to overcome the drawbacks of the prior art by providing a magnetic high frequency connector that uses an area with a weaker magnetic field to install the transmission pins, so as to reduce the interference of the magnetic members.

To achieve the aforementioned objective, the present invention discloses a magnetic high frequency connector comprising a male end portion, a first outer casing, a plurality of first magnetic members, at least one moving terminal, a second outer casing and a female end portion. Wherein, the male end portion has an accommodation space, and the first outer casing covers the male end portion and has a plurality of fixing slots. The first magnetic members are installed in the fixing slots, and two adjacent first magnetic members have a magnetic end spacing and are substantially situated in a heteropolar state, so that a distribution of lines of magnetic force forms at least one weak magnetic area and at least one strong magnetic area in the accommodation space. The moving terminal is installed in the weak magnetic area. The second outer casing has a magnetic portion, and the female end portion is covered by the second outer casing and has at least one fixed terminal, and when the first magnetic members abut against the magnetic portion due to magnetic attraction, the moving terminal and the fixed terminal are electrically coupled to each other. Therefore, when the moving terminal and the fixed terminal are electrically coupled to each other, the magnetic high frequency connector can transmit signals, and the moving terminal disposed in a weak magnetic area with a weaker magnetic field and electrically coupled to the fixed terminal can be operated with minimum electromagnetic interference to reduce the signal transmission interference caused by the first magnetic members, so as to improve the signal transmission performance.

Preferably, the fixing slots are in a surrounding state and disposed at a side of the male end portion. Therefore, the first magnetic members of the fixing slots disposed on the cross-section of the first outer casing are disposed at the side edge of the moving terminal and around the moving terminal in a surrounding manner. The first magnetic members can abut against the magnetic portion accurately by magnetic attraction to improve the convenience of use of the magnetic high frequency connector and reduce the damage rate of the magnetic high frequency connector.

In another embodiment, the fixing slots are arrange in a state of being substantially parallel to each other and disposed on a side edge of the male end portion. Therefore, the first magnetic members of the fixing slots disposed on the cross-section of the first outer casing are arranged to be parallel to the moving terminal to facilitate producing and manufacturing the first outer casing and installing the first magnetic members.

In addition, when two or more moving terminals are used in the invention, the distance between the moving terminals is greater than or equal to the magnetic end spacing. Therefore, the first magnetic members are arranged densely at the side edge of the moving terminals, and the distribution of lines of magnetic force between the first magnetic members is more densely and thus will not affect the moving terminals, so as to reduce the magnetic interference of the signal transmission.

The magnetic high frequency connector further comprises a magnetized member disposed between the first outer casing and the male end portion. With the magnetized member, the first magnetic members are magnetized to block the distribution of lines of magnetic force and reduce the distribution of lines of magnetic force passing through the moving terminal, so as to improve the transmission quality.

The magnetized member is made of metal to facilitate magnetization and improve the interference by the magnetic field.

In addition, the magnetic portion has a plurality of second magnetic members, and the magnetic polarity distribution is opposite to the magnetic polarity distribution of the first magnetic members. When the first outer casing and the second outer casing are close to each other, the first magnetic members and the second magnetic members can be coupled to each other more accurately and stably by the characteristic of the magnetic poles.

In addition, the weak magnetic area and the strong magnetic area are arranged in a substantially staggered distribution state. Therefore, a single moving terminal may be arranged in the weak magnetic area to facilitate its application to a transmission line of a single transmission pin such as an audio line.

Preferably, the strong magnetic area is substantially in a state of surrounding the weak magnetic area, and provided for installing the plurality of moving terminals, and the strong magnetic area may be in a centralized distribution state or a scattered distribution state to facilitate the application of the magnetic high frequency connector to various different transmission lines such as a computer screen transmission line.

In summation, the magnetic high frequency connector of the present invention can be electrically connected by magnetic attraction for transmitting signals and the invention is characterized in that the moving terminal is arranged in the weak magnetic area to reduce the magnetic field interference produced by the first magnetic member during signal transmissions, so as to improve the signal transmission performance and quality of the magnetic high frequency connector. Further, the magnetization of the magnetized member can block the distribution of lines of magnetic force to reduce the magnetic field of the weak magnetic area, so as to improve the performance of the signal transmission.

### BRIEF DESCRIPTION OF THE DRAWINGS

FIG. 1A is a first schematic view showing the distribution of lines of magnetic force of a prior art;

FIG. 1B is a second schematic view showing the distribution of lines of magnetic force of a prior art;

FIG. 2 is a perspective view of a preferred embodiment of the present invention;

FIG. 3A is a cross-sectional view of a preferred embodiment of the present invention;

FIG. 3B is a cross-sectional view of another implementation mode of a preferred embodiment of the present invention;

FIG. 3C is a cross-sectional view of a further implementation mode of a preferred embodiment of the present invention;

FIG. 4A is a schematic view showing the distribution of lines of magnetic force in accordance with another embodiment of the present invention;

FIG. 4B is a schematic view showing the distribution of lines of magnetic force in accordance with another implementation mode of another embodiment of the present invention;

FIG. 4C is a schematic view showing the distribution of lines of magnetic force in accordance with a further implementation mode of another embodiment of the present invention; and

FIG. 5 is a schematic view showing an application in accordance with a preferred embodiment of the present invention.

### DESCRIPTION OF THE PREFERRED EMBODIMENTS

The above and other objects, features and advantages of this disclosure will become apparent from the following detailed description taken with the accompanying drawings.

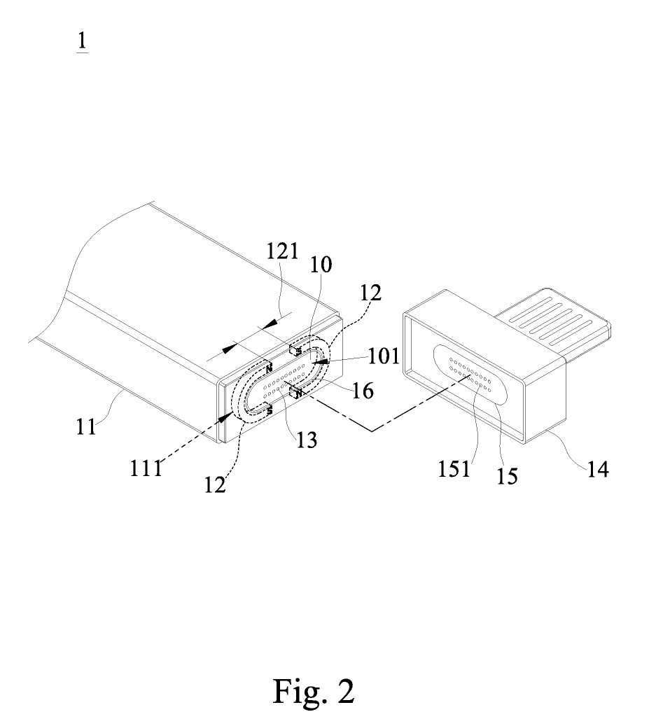

With reference to FIG. 2 for a perspective view of a magnetic high frequency connector in accordance with a preferred embodiment of the present invention, the magnetic high frequency connector 1 comprises a male end portion 10, a first outer casing 11, a plurality of first magnetic members 12, at least one moving terminal 13, a second outer casing 14 and a female end portion 15. Wherein, the male end portion 10 has an accommodation space 101, and the first outer casing 11 covers the male end portion 10 and has a plurality of fixing slots 111. The first magnetic members 12 are disposed in the fixing slots 111, and two adjacent first magnetic members 12 have a magnetic end spacing 121 in between and substantially situated in a heteropolar state, and a distribution of lines of magnetic force forms at least one weak magnetic area 122 and at least one strong magnetic area 123 in the accommodation space 101, and the moving terminal 13 is installed in the weak magnetic area 122. In addition, the second outer casing 14 has a magnetic portion (not shown in the figure), and the female end portion 15 is covered by the second outer casing 14 and has at least one fixed terminal 151. With reference to FIG. 5 for a schematic view showing an application of the invention, the first outer casing 11 is electrically coupled to a charging cable 3 of a mobile phone 2, and the second outer casing 14 is electrically coupled to the mobile phone 2. When the first magnetic members 12 abut against the magnetic portion due to magnetic attraction, the moving terminal 13 and the fixed terminal 14 are electrically coupled to each other for transmitting signals. Now, the mobile phone 2 and its charging cable 3 are electrically coupled to each other to charge the mobile phone.

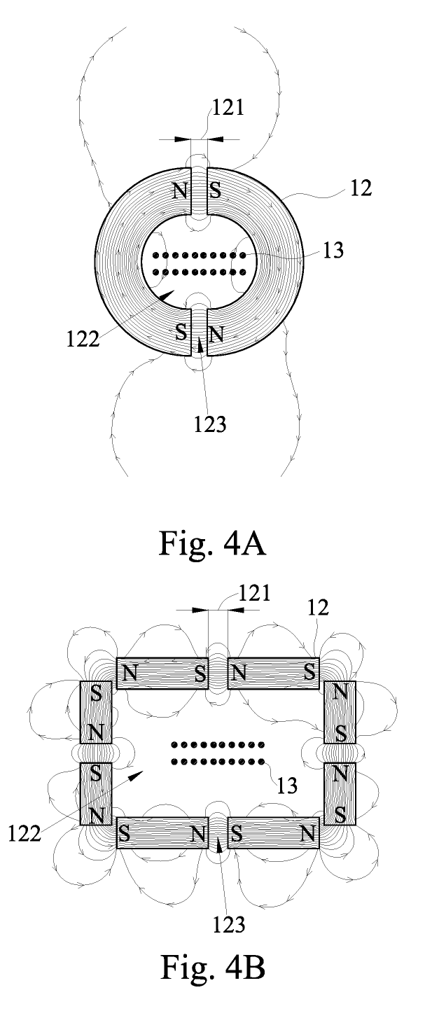

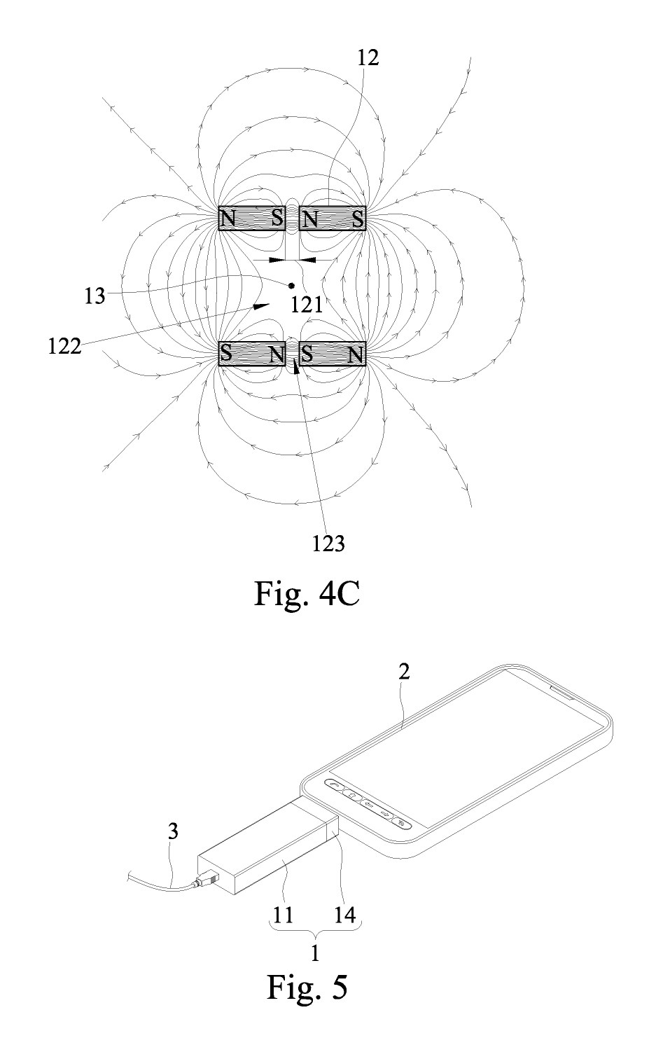

With reference to FIG. 4A for a schematic view showing a distribution of lines of magnetic force of another embodiment of the present invention, the curve in the figure simulates the line of magnetic force, and the arrow in the figure indicates the direction of a magnetic field, and the moving terminal 13 comes with a plural quantity. In the figure, a more scattered distribution of lines of magnetic force shows that the intensity of the magnetic field in this area (which is the weak magnetic area 122) is smaller. On the other hand, a denser distribution of lines of magnetic force shows that the intensity of the magnetic field in this area (which is the strong magnetic area 123) is greater. Wherein, the first magnetic member 12 comes with a plural quantity, and the two adjacent first magnetic members 12 are in the state of opposite polarities, and a dense distribution of lines of magnetic force is formed at a position where the first magnetic members are next to each other to restrict the magnetic flux passing through the moving terminal 13, so that the weak magnetic area 122 and the strong magnetic area 123 with a large difference of the intensity of the magnetic field are formed in the accommodation space 101. Therefore, the moving terminals 13 disposed in the weak magnetic area 122 can avoid the passing-through of the dense lines of magnetic force to reduce the magnetic field interference. During a signal transmission performed by the magnetic high frequency connector 1, the moving terminal 13 is electrically coupled to the fixed terminal 151, and the moving terminals 13 are disposed in the weak magnetic area 122 with a weaker magnetic field, so that the electromagnetic interference can be reduced to lower the signal transmission interference caused by the electromagnetic field and to improve the signal transmission performance.

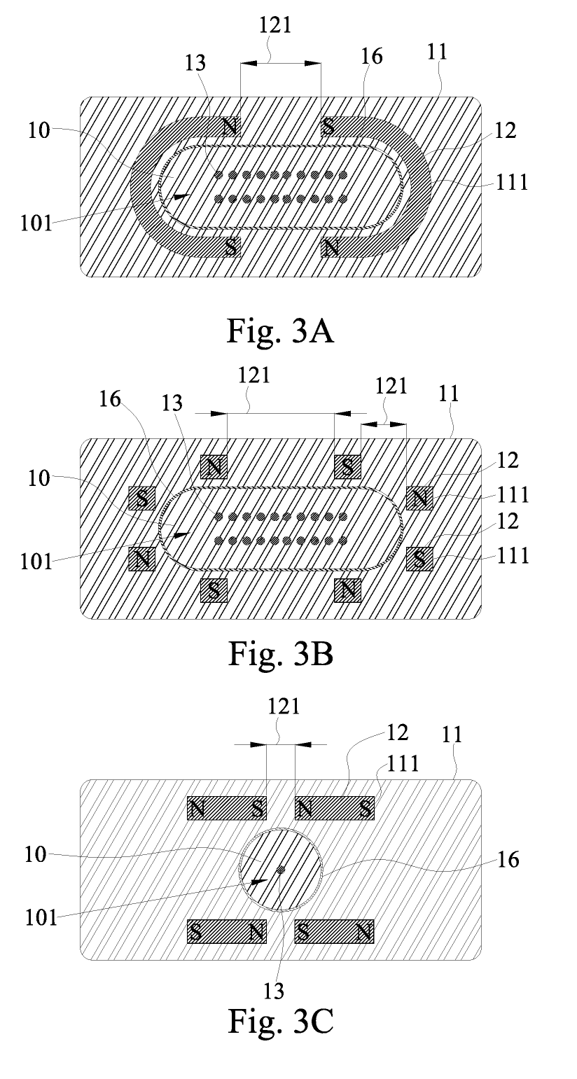

With reference to FIGS. 2, 3A, 3B and 3C for this embodiment of the invention, the magnetic high frequency connector 1 further comprises a magnetized member 16 installed between the first outer casing 11 and the male end portion 10, so that the magnetized member 16 is in a state of surrounding the moving terminals 13. When the first magnetic members 12 abut against the magnetic portion, the magnetic field so generated will magnetize the magnetic member 16. The two adjacent first magnetic members 12 are in a substantially heteropolar state, so that the magnetic member 16 generates another irregular magnetic field distribution to interfere with the distribution of lines of magnetic force of the first magnetic members 12 and the magnetic portion and block the line of magnetic force from passing to the moving terminals 13. When the moving terminals 13 are electrically coupled to the fixed terminals 151 to transmit signals, the magnetized magnetic member 16 can further reduce the lines of magnetic force that pass through the moving terminal 13 and the fixed terminal 151, so as to reduce the intensity of the magnetic field of the weak magnetic area 122 and improve the signal transmission quality.

In this embodiment, the first magnetic members 12 are magnets, and the magnetized member 16 is made of metal. When the first magnetic members 12 abut against the magnetic portion due to magnetic attraction, the magnetized member 16 can be magnetized more easily, and a chaotic magnetic moment distribution is formed inside the metal material. The magnetic interference performance of the magnetic member 16 can be improved by the magnetized feature of the metal.

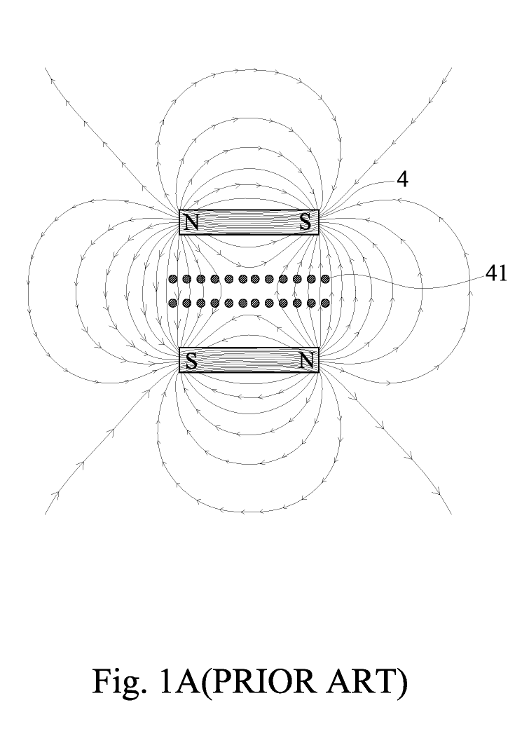

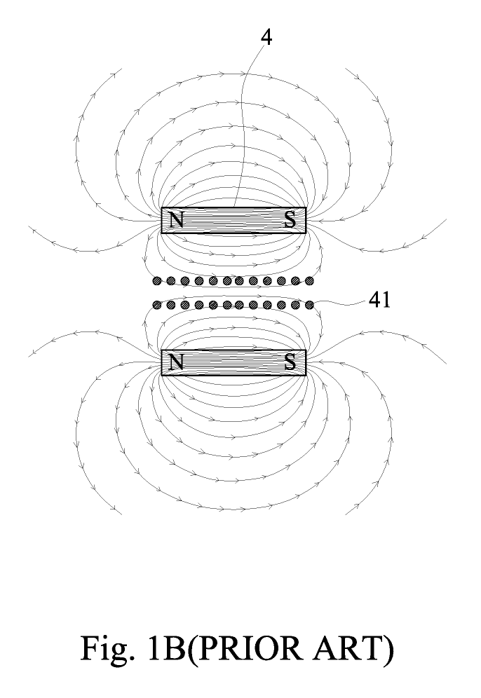

With reference to FIGS. 2, 3A and 3B for the perspective view of the present invention and the cross-sectional views in accordance with two implementation modes of the present invention respectively, the fixing slots 111 are in a surrounding state and disposed at a side edge of the male end portion 10, so that the first magnetic members 12 in the fixing slots 111 can be installed around the side edge of the moving terminal 13. The first magnetic members 12, the magnetized member 16, and the moving terminals 13 are arranged sequentially from the outermost side of the first outer casing 11 to the center position of the male end portion 10. Therefore, the first magnetic members 12 can abut accurately against the magnetic portion due to magnetic attraction, and the moving terminal 13 in the male end portion 10 can be electrically coupled to the fixed terminal 151 in the female end portion 15 accurately, and a good stability can be maintained when the moving terminal 13 is electrically coupled to the fixed terminal 151. With reference to FIGS. 4A and 4B for the schematic views showing the distribution of lines of magnetic force in accordance with two different implementation modes of another embodiment of the present invention respectively, the embodiment does not have the magnetized member 16 in order to compare with the prior art as depicted in FIGS. 1A and 1B. When the first magnetic members 12 are in the state of surrounding the moving terminals 13, the difference of the magnetic field distributions is very large, and thus greatly decreasing the intensity of the magnetic field in the weak magnetic area 122, so that the moving terminals 13 can avoid the dense lines of magnetic force. Such arrangement not just increases the stability of the magnetic high frequency connector 1 only, but also improve the signal transmission performance.

In another implementation mode of this embodiment, the fixing slots 111 are arranged in a state of being substantially parallel to each other and disposed at a side edge of the male end portion 10 as shown in the cross-sectional view of FIG. 3C, and the first magnetic members 12 are arranged parallel to each other and disposed at the side edge of the moving terminal 13. Therefore, the fixing slots 111 can be designed and produced more easily when the first outer casing 11 and the first magnetic members 12 are manufactured, and the fixing slots 11 are provided for facilitating the installation of the first magnetic members 12. With reference to FIG. 4C for a schematic view showing a distribution of lines of magnetic force in accordance with a further implementation mode of another embodiment and FIG. 1A for the comparison with the prior art, the present invention restricts the distribution of the lines of magnetic force by two adjacent first magnetic members 12 to limit the magnetic flux passing through the moving terminal 13, so as to reduce the influence of the magnet 4 to the transmission pin 41. With reference to FIG. 3C for a cross-sectional view of a further implementation mode of a preferred embodiment of the present invention, a single moving terminal 13 is disposed at the center of the accommodation space 101 and applied as an audio line, video signal transmission line or BNC video surveillance line to achieve a better signal quality and facilitate producing and manufacturing the first outer casing 11 and installing the first magnetic members 12.

Further, when the moving terminal 13 comes with a plural quantity, the distance between the moving terminals 13 is greater than or equal to the magnetic end spacing 121. Therefore, the first magnetic members 12 are densely arranged at the side edge of the moving terminals 13, and the heteropolar magnetic poles reduce the distribution of lines of magnetic force significantly, so that the distribution of lines of magnetic force between two adjacent first magnetic members 12 becomes denser, and thus increasing the difference between the magnetic fields of the strong magnetic area 123 and the weak magnetic area 122. As a result, when the magnetic high frequency connector 1 is operated, the influence of the electromagnetic field on the moving terminals 13 and the fixed terminals 151 can be avoided to reduce the interference of the magnetic fields to the signal transmission, so as to improve the performance of the magnetic high frequency connector 1 significantly.

In addition, the magnetic portion has a plurality of second magnetic members (not shown in the figure), and their magnetic polarity distributions are opposite to the magnetic polarity distribution of the first magnetic members 12, and the second magnetic members are also magnets. Therefore, when the first outer casing 11 and the second outer casing 14 are close to each other, opposite polarity of the magnet poles of the first magnetic members 12 and the second magnetic members can drive the first outer casing 11 to abut against the second outer casing 14 more accurately to achieve the effects of preventing a collision caused by moving the outer casings 11, 14 to wrong positions due to the magnetic attraction, and maintaining a good stability of the connection. The invention can further improve the performance and stability of use and reduce the damage rate of the magnetic high frequency connector 1.

In FIG. 4C, the weak magnetic area 122 and the strong magnetic area 123 are situated at a staggered distribution state. As disclosed in FIG. 3C, a single moving terminal 13 is installed in the weak magnetic area 122, or the plurality of moving terminals 122 are concentrated in the weak magnetic area 122 to facilitate its application to a transmission line of a single transmission pin such as an audio line, a video signal transmission line, etc.

With reference to FIGS. 3A, 3B, 4A, and 4B, the strong magnetic area 123 is in a state of surrounding the weak magnetic area 122 and has the plurality of moving terminals 13 arranged substantially in a state of a concentrated distribution or a scattered distribution, so as to facilitate the magnetic high frequency connector 1 to be applied to various types of transmission lines, particularly to the transmission connector requiring a plurality of pins such as a computer screen transmission line or a transmission line for various USB connectors.

In summation of the description above, the magnetic high frequency connector 1 of the present invention can be electrically connected by magnetic attraction and provided for transmitting signals. The invention is characterized in that the intensity of the magnetic field of the first magnetic members 12 varies, and the moving terminal 13 is installed in the weak magnetic area 122 with a weaker magnetic field, so as to reduce the magnetic flux passing through the moving terminal 13. During the operation of the magnetic high frequency connector 1, the signal transmitted by the moving terminal 13 and the fixed terminal 151 can be avoided from being affected by electromagnetic interference, so as to improve the signal transmission performance and quality. In addition, the magnetized member 16 is provided for blocking the magnetic field distribution of the first magnetic members 12 to further decrease the magnetic field of the weak magnetic area 122, so as to improve the quality of the transmitted signals.

While the invention has been described by means of specific embodiments, numerous modifications and variations could be made thereto by those skilled in the art without departing from the scope and spirit of the invention set forth in the claims.

What is claimed is:

1. A magnetic high frequency connector, comprising:
a male end portion, having an accommodation space;
a first outer casing, covering the male end portion and having a plurality of fixing slots;
a plurality of first magnetic members, disposed in the plurality of fixing slots, and any two adjacent first magnetic members having a magnetic end spacing and substantially situated in a heteropolar state, and a distribution of lines of magnetic force forming at least one weak magnetic area and at least one strong magnetic area in the accommodation space;
at least one moving terminal, installed in the weak magnetic area;
a second outer casing, having a magnetic portion; and
a female end portion, covering the second outer casing, and having at least one fixed terminal, and the moving terminal and the fixed terminal being electrically coupled to each other when the plurality of first magnetic members abut against the magnetic portion due to magnetic attraction,

2. The magnetic high frequency connector according to claim 1, wherein, the plurality of fixing slots are substantially in a surrounding state and disposed at a side edge of the male end portion.

3. The magnetic high frequency connector according to claim 1, wherein, the plurality of fixing slots are arranged in a state of being substantially parallel to each other and disposed on a side edge of the male end portion.

4. The magnetic high frequency connector according to claim 1, wherein a distance between the moving terminals is greater than or equal to the magnetic end spacing, if the moving terminal comes with a plural quantity.

5. The magnetic high frequency connector according to claim 4, further comprising a magnetized member disposed between the first outer casing and the male end portion.

6. The magnetic high frequency connector according to claim 5, wherein the magnetized member is made of metal.

7. The magnetic high frequency connector according to claim 6, wherein the magnetic portion has a plurality of second magnetic members with a magnetic polarity distribution configured opposite to the magnetic polarity distribution of the plurality of first magnetic members.

8. The magnetic high frequency connector according to claim 1, wherein, the weak magnetic area and the strong magnetic area are in a substantially staggered distribution state.

9. The magnetic high frequency connector according to claim 1, wherein, the strong magnetic area is substantially in a state of surrounding the weak magnetic area.

10. The magnetic high frequency connector according to claim 2, wherein a distance between the moving terminals is greater than or equal to the magnetic end spacing, if the moving terminal comes with a plural quantity.

11. The magnetic high frequency connector according to claim 10, further comprising a magnetized member disposed between the first outer casing and the male end portion.

12. The magnetic high frequency connector according to claim 11, wherein the magnetized member is made of metal.

13. The magnetic high frequency connector according to claim 12, wherein the magnetic portion has a plurality of second magnetic members with a magnetic polarity distribution configured opposite to the magnetic polarity distribution of the plurality of first magnetic members.

14. The magnetic high frequency connector according to claim 3, wherein a distance between the moving terminals is greater than or equal to the magnetic end spacing, if the moving terminal comes with a plural quantity.

15. The magnetic high frequency connector according to claim 14, further comprising a magnetized member disposed between the first outer casing and the male end portion.

16. The magnetic high frequency connector according to claim 15, wherein the magnetized member is made of metal.

17. The magnetic high frequency connector according to claim 16, wherein the magnetic portion has a plurality of second magnetic members with a magnetic polarity distribution configured opposite to the magnetic polarity distribution of the plurality of first magnetic members.
